(19) United States
(12) Patent Application Publication
(10) Pub. No.: US 2025/0108784 A1
(43) Pub. Date: Apr. 3, 2025

(54) METHOD FOR CONTROLLING THE FORCE OF AN ELECTROMECHANICAL MOTOR VEHICLE BRAKE, AND ELECTROMECHANICAL MOTOR VEHICLE BRAKE

(71) Applicant: Continental Automotive Technologies GmbH, Hannover (DE)

(72) Inventors: Peter Stauder, Mainz (DE); Jürgen Böhm, Oberneisen (DE)

(73) Assignee: Continental Automotive Technologies GmbH, Hannover (DE)

(21) Appl. No.: 18/980,012

(22) Filed: Dec. 13, 2024

(30) Foreign Application Priority Data
Dec. 19, 2023 (DE) 10 2023 212 916.7

(51) Int. Cl. B60T 8/172; B60T 13/74

(52) U.S. Cl. CPC B60T 8/172; B60T 13/741

(57) ABSTRACT

A method for controlling the force of an electromechanical motor vehicle brake and a motor vehicle brake having an electromechanical motor vehicle brake for carrying out the method are disclosed. The method comprises checking whether a braking power does not exceed a specified limit value for the maximum power of an actuator and reducing or modifying a target actuator speed to a modified target actuator speed if the specified limit value is exceeded.

### TECHNICAL FIELD

A method for controlling the force of an electromechanical motor vehicle brake and a motor vehicle brake having an electromechanical motor vehicle brake are disclosed.

### BACKGROUND

Electrically actuable motor vehicle brakes, also referred to as electromechanical motor vehicle brakes, are increasingly being employed as brake systems for motor vehicles. These motor vehicle brakes no longer need a complex hydraulic system, and an electromechanical wheel brake also takes up significantly less space.

Electromechanical wheel brakes of this kind typically have an electric or electronic drive unit, which interacts with a mechanism or a transmission. A braking unit can then be arranged on the output side, and this can comprise a brake piston with a friction lining, which can be pressed onto a brake disk or drum by means of a translational movement. It is thereby possible to bring about deceleration during operation.

Here, the electric drive unit can comprise an electrically driven motor, for example a brushless electric motor, also referred to as an actuator below. Controlling the force of such actuators is of importance since-unlike, for example, in the case of hydraulically actuable wheel brakes-feedback to a driver can often no longer be performed, amongst other things.

Therefore, a force controller unit, which can comprise a force controller, is generally provided for controlling the actuator. The force controller can generate a target value for the actuator speed or rotation speed in a known manner based on a specified target force, which can correspond to a driver's braking request, in order to set this target force as quickly as possible. The application of the wheel brake, that is to say the application of the brake application force in the brake application direction, of the electromechanical motor vehicle brake can be performed in this way.

For example, in the event of sudden changes in the target clamping force, as may occur when a strongly applied wheel brake is released quickly, so-called overshoots or undershoots can occur. This means that the desired target forces can be undershot or exceeded when the change is made. This is a risk in the case of disk brakes, which comprise a brake caliper.

Accordingly, a method for controlling an electromechanical wheel brake, which method does not exhibit or at least mitigates the abovementioned, is desirable.

### SUMMARY

This object is achieved by a method for controlling an actuator, for example an electric motor for operating an electromechanical motor vehicle brake, and by an electromechanical motor vehicle brake of this kind.

The method comprises at least the following steps:
providing a target value to be achieved for the clamping force of the actuator as the target clamping force F_{target},
calculating a target value for the actuator speed as the target actuator speed ω_{act, target} based on the target clamping force F_{target},
calculating a torque M_{act, target} based on the target actuator speed ω_{act, target},
calculating the required braking power of the actuator P_{act, target} based on the torque M_{act, target} and the target actuator speed ω_{act, target},
checking whether the braking power P_{act, target} exceeds a specified limit value for the maximum power of the actuator P_{act, max},
reducing the target actuator speed ω_{act, target} to a modified target actuator speed ω_{act, target, mod} if the specified limit value P_{act, max} is exceeded,
operating the actuator at the target actuator speed ω_{act, target} or the modified target actuator speed ω_{act, target, mod} to achieve the target clamping force F_{target}.

The actuator can comprise an electric motor, for example an electric motor for operating an electromechanical motor vehicle brake of a motor vehicle. For the purposes of the embodiments, a motor vehicle refers to a vehicle having axles, wherein at least one of these axles can comprise steerably guided wheels and, furthermore, the driving of the wheels on at least one axle can be adapted in a wheel-specific manner.

Accordingly, a force controller unit can be provided for carrying out the abovementioned method. The force controller unit can be understood to mean, for example, a functional unit, which is designed to realize the functions mentioned. For example, it can be of modular construction. The force controller unit can be implemented, for example, using hardware or using software. It can be designed, for example, as a microcontroller, microprocessor, application-specific integrated circuit (ASIC), programmable logic controller or as another programmable or hard-wired unit. For example, the force controller unit can have processor means and storage means, wherein program code is stored in the storage means, the processor means executing a functionality as specified herein when the program code is executed.

The force controller unit can comprise a force controller which is designed to generate a target value for the actuator speed as the target actuator speed ω_{act, target} based on a specified target force F_{target} for the clamping force of the actuator. The force controller can reproduce the functionality already known from the prior art, to generate an actuator speed target value based on a target force. Providing the target clamping force F_{target} can be performed by a vehicle controller, by an on-board computer or another vehicle computer.

Here, the target actuator speed ω_{act, target} is typically that value which an actuator, for example an electric motor, is intended to set as the speed, for example angular speed, in order to achieve the desired specified target force F_{target}. If the specified target force is currently achieved, the target actuator speed is typically zero.

If the electromechanical motor vehicle brake accordingly applies a force that is greater or less than the specified target force, the desired specified target force can be set by a negative or positive actuator speed. This is typically maintained until the desired target force is set, then the target value for the actuator speed is zero again.

For the purposes of the embodiments, provision is made for the specified value for the negative or positive actuator speed ω_{act, target} for achieving the desired target force F_{target} with respect to certain restrictions, which can result for example from the actuator or electric motor and the type and the brake application state of the wheel brake, to be checked and, if specified limit values are exceeded, for the actuator speed ω_{act, target} to be correspondingly modified and/or corrected, for example reduced. The objective of this is to prevent these limit values or restrictions from being exceeded and undesired operating conditions from being reached.

A modification unit can be provided for this purpose. The modification unit can also be understood to mean a functional unit, which is designed to realize the functions mentioned. It can also be of modular construction, or else can be implemented, for example, in the force controller. The modification unit can be designed, for example, as a microcontroller, microprocessor, application-specific integrated circuit (ASIC), programmable logic controller or as another programmable or hard-wired unit. For example, the modification unit can have processor means and storage means, wherein program code and modification parameters are stored in the storage means.

According to an embodiment, the method makes provision for providing a target value to be achieved for the clamping force of the actuator as the target clamping force F_{target}, followed by calculating a target value for the actuator speed as the target actuator speed ω_{act, target} based on the target clamping force F_{target}. On this basis, the torque M_{act, target} can be calculated based on the target actuator speed ω_{act, target}. Typically, the underlying rules are determined in such a way that the target clamping force F_{target} is achieved as rapidly as possible in order to achieve the required new braking torque as quickly as possible. As a result, the calculated target actuator speed ω_{act, target} can often be determined solely depending on the technical parameters of the actuator, such as the maximum actuator speed, or can be limited by these technical parameters. However, this does not take into account whether or the extent to which the wheel brake is already applied. Specifically in the case of wheel brakes which are designed as disk brakes and comprise a brake caliper, this can lead to what is known as overshooting or undershooting when a strongly applied wheel brake is released quickly. This means that the desired target forces can be undershot or exceeded during the change to be made and consequently the desired target clamping force F_{target} is achieved with a delay.

To check whether there is a risk of an undershoot or overshoot, according to the invention, the required braking power of the electric motor or the actuator P_{act, target} is initially calculated based on the torque M_{act, target} and the target actuator speed ω_{act, target}. This braking power is required so that the actuator can be held exactly at the new desired point and the required target clamping force F_{target} can also be achieved at this desired point, without undershooting or overshooting occurring. Based on this braking power P_{act, target}, it is then possible to check whether a specified power limit of the actuator P_{act, max} could be exceeded. A check is therefore made as to whether the braking power P_{act, target} exceeds a specified limit value for the maximum power of the actuator P_{act, max}.

In this case, the required braking power of the actuator P_{act, target} can no longer be ensured in the best possible way, and there is a risk of undershooting or overshooting. This provides for the target actuator speed ω_{act, target} to be reduced to a modified target actuator speed ω_{act, target, mod} if the braking power P_{act, target} exceeds the specified limit value P_{act, max}.

Accordingly, if the limit value for the maximum power is exceeded, the actuator can then be operated at the modified target actuator speed ω_{act, target, mod} instead of the target actuator speed ω_{act, target} in order to reach the target clamping force F_{target}.

According to an embodiment, provision is made here for the currently applied clamping force of the actuator to be detected as the actual clamping force F_{actual}. The actual clamping force F_{actual} can be measured, for example, by a force sensor or using a model stored in a memory.

The actual clamping force F_{actual} can thus be used to detect whether the wheel brake is already applied at the time at which the target clamping force F_{target} is requested. In other words, it is possible to detect whether and to what extent a brake application force of the wheel brake is already acting. The method can therefore make provision for the actual clamping force F_{actual} to additionally be taken into account for calculating the torque M_{act, target}.

The actuator may be installed in a component that is at least partially expandable or deformable, such as a brake caliper. The background is that the housing, for example a brake caliper housing, can act like a spring, which can generate corresponding counterforces on the actuator when a brake is applied and released. A torque working in the opposite direction can therefore act at the interface between the actuator and the transmission, said torque being proportional to the current actual clamping force F_{actual} and it being possible for a frictional torque, which is mainly dependent on the direction of rotation, to be superimposed on said torque. The occurrence of an undershoot in the force control is determined by the ratio of the maximum torque or the maximum power of the actuator to the return torque or the return power of the load. Here, the return power corresponds to the product of the current rotation speed and the return torque.

Since an actuator or an electric motor can only provide a smaller torque at high rotation speeds due to a power limitation than at low rotation speeds, unfavorable operating parameters can lead to overloading or to undesired operating states of the actuator under certain conditions. If, for example, the actuator is accelerated backward at a maximum when the clamping force is high and the actuator is stationary, the return power can become greater than the maximum permissible motor power by superimposing the motor torque and the return torque.

In this case, the rotation speed can then no longer be reduced, but rather the increase can only be slowed down by the motor torque. In said case, the actuator can remain in this operating state until the return power has fallen below the maximum motor power again by increasingly releasing the brake. As a result, it may be the case that a desired target clamping force F_{target} cannot be precisely adhered to, but rather is, for example, undershot, which can then lead to the abovementioned undershoot. This may be unfavorable, specifically in conjunction with wheel brakes, since a requested braking force may not be achieved as desired or may be achieved only with a delay.

By taking into account the actual clamping force F_{actual} when calculating the torque M_{act, target} and calculating the required braking power of the actuator P_{act, target}, the risk of undershoots or overshoots can be identified in time by the force controller before a potentially critical condition is reached. The target actuator speed ω_{act, target} is modified expediently to a value P_{act, mod}, at which the required braking power of the actuator does not exceed the limit value P_{act, max}. In this way, it is possible to prevent the actuator from entering the undesired operating state. Modifying the target actuator speed can be performed in a computer-assisted manner by the modification unit.

According to a development, provision is made for the target actuator speed ω_{act, target} or the target actuator speed ω_{act, target, mod} to be corrected once again, for example to be reduced further. Using a correction factor k, the target actuator speed ω_{act, target} or the target actuator speed ω_{act, target, mod} can accordingly be further reduced when k<=1.

This correction factor k can be selected depending on other factors and parameters, including for example the current temperature of the actuator, the availability of the on-board electrical system or else possible noise emissions, which can occur for instance at certain critical rotation speeds or actuator speeds. The correction factor k can be selected, for example, from a matrix stored in a memory.

Consequently, provision may be made for the target actuator speed ω_{act, target, mod} to once again be limited or reduced to a modified, corrected target actuator speed ω_{act, target, corr} by means of a correction factor k and for the actuator to be operated at the corrected target actuator speed ω_{act, target, corr}.

According to an embodiment, provision may also be made for modifying and/or correcting the target actuator speed ω_{act} to be suspended under certain circumstances. This may be helpful, for example, when a hazardous situation is identified. For example, sensors of the motor vehicle report that the motor vehicle is approaching an object or another motor vehicle and consequently achieving the target clamping force F_{target} as quickly as possible has priority over all modifications and/or corrections. In such cases, for example, the correction factor or the correction of the target actuator speed ω_{act, target} can be suspended according to certain rules. For example, the correction of the target actuator speed ω_{act, target, mod} with regard to critical rotation speeds, for example with regard to noise emissions, can therefore be suspended since, for example, in emergencies where rapid and effective braking of the motor vehicle is required, the possible noise is given a lower priority.

Even in conjunction with an ABS controller, suspending, modifying, and/or correcting the target actuator speed ω_{act, target}, for example if the wheel has too much slip and an increase in track stability and stopping of the wheel are intended to be prevented. The braking distance can be further reduced in this way.

Consequently, modifying and/or correcting the target actuator speed ω_{act, target} can be overridden or suspended if the superordinate vehicle controller, the on-board computer or the vehicle computer specifies this. The corresponding rules can be stored in a memory of the modification unit.

According to a development, prioritization of the modifications and/or corrections to be carried out can also be performed by the vehicle controller, the on-board computer or the vehicle computer, wherein, for example, a decision matrix stored in a memory can be accessed. For example, different types of prioritization can also be stored in the decision matrix depending on the factors and the correction factor k can be accordingly selected.

According to one embodiment, provision may be made here for modifying the target actuator speed ω_{act, target} to the modified target actuator speed ω_{act, target, mod} and/or correcting the target actuator speed ω_{act, target, mod} to the corrected target actuator speed ω_{act, target, mod, corr} to be performed precisely once. This can advantageously be performed when a braking cycle starts and the target clamping force F_{target, holding} to be newly set differs from the currently set actual clamping force F_{actual}. Depending on the outcome of the check, the actuator can then be operated at the once defined target actuator speed ω_{act, target, mod} or the corrected target actuator speed ω_{act, target, mod, corr} until the new target clamping force F_{target, holding} is achieved.

According to a further embodiment, provision may be made for modifying the target actuator speed ω_{act, target} to the modified target actuator speed ω_{act, target, mod} and/or correcting the target actuator speed ω_{act, target, mod} to the corrected target actuator speed ω_{act, target, mod, corr} to be repeatedly, cyclically, performed during the current braking process. This makes it possible to change modifying and/or correcting the target actuator speed ω_{act, target} in order to be able to react, for example, to changes that occur.

In a further aspect, a force controller unit, for example for use in or with a control device for a motor vehicle brake, designed for carrying out a method as described above.

Yet a further aspect, also relates to a motor vehicle comprising an electromechanical motor vehicle brake having a force controller unit as described above.

Compared to solutions with generally stronger limiting of the target actuator speed, the target force-dependent modification and/or correction of the target actuator speed ω_{act, target} offers that the highest possible system dynamics can be maintained. As a result, this means that the motor vehicle brake can be controlled with high dynamics, but at the same time the specific actual brake application force can also be taken into account in order to prevent overshooting or undershooting by the actuator.

Therefore, control quality, especially with regard to clamping force control, can be achieved, as a result of which, for example, braking distances can be shortened in conjunction with ABS control.

It is also possible to dispense with distance limiting by means of appropriate mechanical stops since the risk of overshooting or undershooting and thus the risk of overshooting mechanical endpoints can be prevented.

Further details of the invention can be gathered from the description of the illustrated exemplary embodiments and the attached claims.

### BRIEF DESCRIPTION OF THE DRAWINGS

In the drawings:

FIG. 1 shows a simplified illustration of a force controller unit for the method for controlling an actuator on the basis of an exemplary embodiment,

FIG. 2 shows the profile of the braking force of an actuator with the target value and the actual value on the basis of an exemplary embodiment, and

FIG. 3 shows the profile of the actuator speed with the target value and the actual value on the basis of a further exemplary embodiment.

### DETAILED DESCRIPTION

In the following detailed description of exemplary embodiments, for the sake of clarity, the same reference signs designate substantially identical parts in or on these embodiments. However, for better clarification, the embodiments illustrated in the figures are not always drawn to scale.

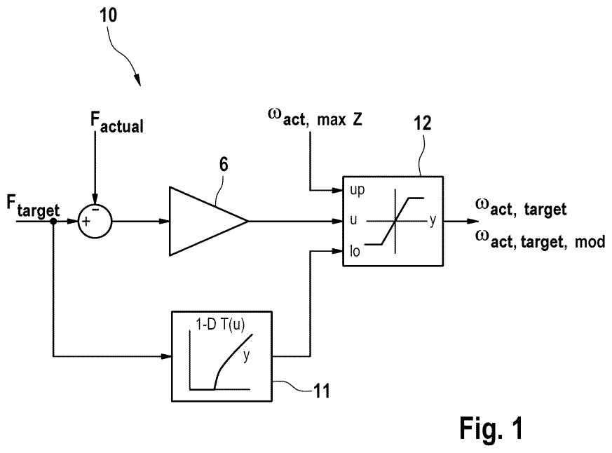

FIG. 1 shows a highly simplified illustration of a force controller unit 10 for the method for controlling an actuator on the basis of an exemplary embodiment in a schematic view. The force controller unit 10 is suitable for carrying out the method.

The force controller unit 10 has an input for the target clamping force F_{target} and an input for the actual clamping force F_{actual}. An input for the maximum actuator speed ω_{act, max Z target} is also provided.

In the exemplary embodiment, the force controller unit 10 has integrated in it the modification unit 11. The modification unit 11 is designed to implement the functions mentioned, for example modifying and/or correcting the target actuator speed ω_{act, target}.

In the exemplary embodiment, the maximum actuator speed ω_{act, max Z target} is provided to a limiter 12, which also receives the information about the target actuator speed ω_{act, target}. The target actuator speed ω_{act, target} or the modified target actuator speed ω_{act, target, mod} or the corrected modified target actuator speed ω_{act, target, corr} is provided as the output variable.

The method for controlling the actuator, for example an electric motor for operating an electromechanical motor vehicle brake, therefore comprises the following steps:
providing a target value to be achieved for the clamping force of the actuator as the target clamping force F_{target},
calculating a target value for the actuator speed as the target actuator speed ω_{act, target} based on the target clamping force F_{target},
calculating a torque M_{act, target} based on the target actuator speed ω_{act, target},
calculating the required braking power of the actuator P_{act, target} based on the torque M_{act, target} and the target actuator speed ω_{act, target},
checking whether the braking power P_{act, target} exceeds a specified limit value for the maximum power of the actuator P_{act, max},
reducing the target actuator speed ω_{act, target} to a modified target actuator speed ω_{act, target, mod} if the specified limit value P_{act, max} is exceeded,
operating the actuator at the target actuator speed ω_{act, target} or the modified target actuator speed ω_{act, target, mod} to achieve the target clamping force F_{target}.

Providing the target clamping force F_{target} is performed by a vehicle controller, but can also be performed by an on-board computer or another vehicle computer.

The method also provides for detecting the currently applied clamping force of the actuator as the actual clamping force F_{actual}, which is taken into account for calculating the torque M_{act, target}. A force sensor is provided for detecting the actual clamping force F_{actual}. However, as an alternative, the actual clamping force Factual can also be provided, for example, using a stored model from a memory.

If the braking power P_{act, target} exceeds a specified limit value for the maximum power of the actuator P_{act, max}, which is determined depending on the actuator and stored in a memory, the target actuator speed ω_{act, target} is limited or reduced to a modified target actuator speed ω_{act, target, mod}. The modified target actuator speed ω_{act, target, mod} is selected in such a way that a maximum power P_{act, mod} of the actuator which does not exceed the limit value P_{act, max} is achieved. In other words, the maximum power P_{act, mod} of the actuator is no longer exceeded owing to the limiting, and the required braking power can be provided exactly.

According to a development, the modified target actuator speed ω_{act, target, mod} is once again limited to a modified, corrected target actuator speed ω_{act, target, corr} by means of a correction factor k and the actuator is operated at the corrected target actuator speed ω_{act, target, corr}. This makes it possible to be able to take into account further parameters and restrictions in conjunction with the operation of the actuator during the actuation, for example including those which may change over the lifetime of the wheel brake or which are subject to use-related fluctuations.

According an embodiment, the correction factor k is selected depending on other factors, including the temperature of the actuator, the availability of the on-board electrical system or critical rotation speeds or actuator speeds, wherein the correction factor k may be selected from a matrix stored in a memory.

According to an embodiment, provision is further made for modifying and/or correcting the target actuator speed ω_{act, target} to be able to be overridden or suspended if the superordinate vehicle controller or the on-board computer or another vehicle computer specifies this. For example, in hazardous situations which are detected by on-board sensors, this may help to provide the maximum or required braking power, where overshooting or undershooting can be accepted under certain circumstances. The correction value k for determining the corrected target actuator speed ω_{act, target, corr} can also be selected using a decision matrix stored in a memory.

According to one embodiment, reducing or modifying the target actuator speed ω_{act, target} and/or correcting the target actuator speed ω_{act, target} are/is performed once when a new target value for the target clamping force F_{target} is received.

According to another embodiment, reducing or modifying the target actuator speed ω_{act, target} and/or correcting the target actuator speed ω_{act, target} are/is repeatedly, cyclically, performed until the target clamping force F_{target}, holding is achieved.

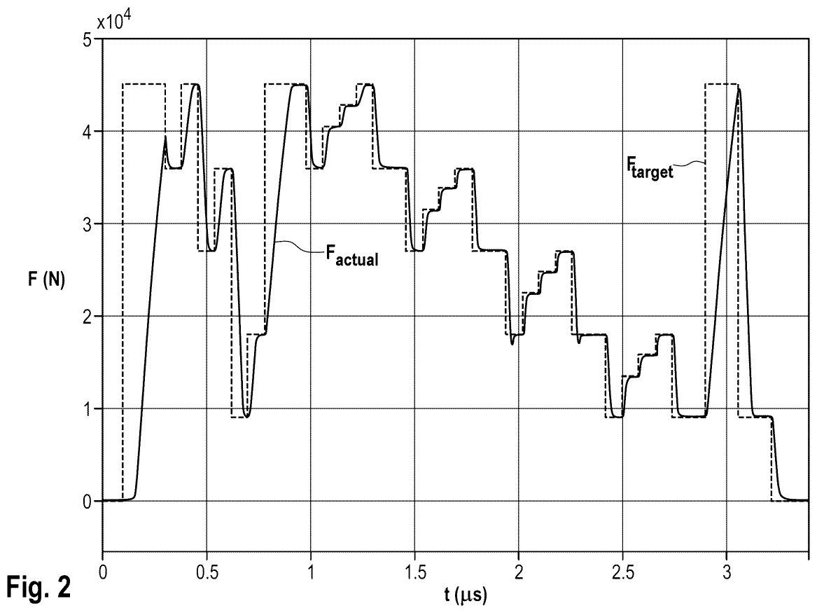

FIG. 2 shows an exemplary profile of the forces in an actuator of a wheel brake. The actuator is designed as an electric motor for operating an electromechanical motor vehicle brake. The graph shows the profile of the target clamping force F_{target} and that of the actual clamping force F_{actual}. The illustration shows that, with the method, even in the case of abrupt changes in the target clamping force F_{target}, the actual clamping force F_{actual} can be achieved quickly.

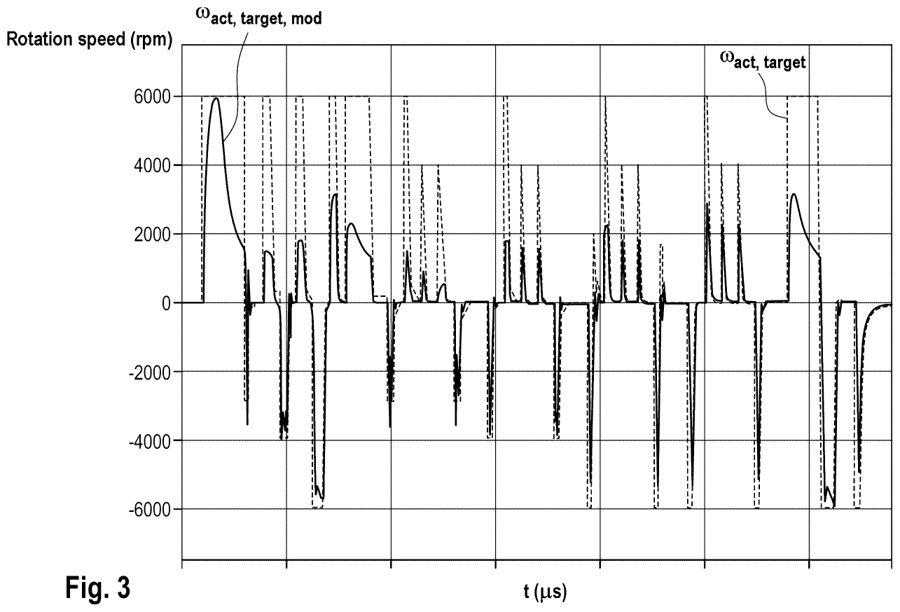

FIG. 3 finally shows an exemplary profile of the actuator speed, with the target actuator speed ω_{act, target} and the current actual actuator speed being shown.

1. A method for controlling an actuator for operating an electromechanical motor vehicle brake comprising:
providing a target value to be achieved for a clamping force of the actuator as a target clamping force;
calculating a target value for an actuator speed as a target actuator speed based on the target clamping force;
calculating a torque based on the target actuator speed;
calculating required braking power of the actuator based on the torque and the target actuator speed;
checking whether the braking power exceeds a specified limit value for a maximum power of the actuator;
reducing the target actuator speed to a modified target actuator speed if the specified limit value is exceeded; and
operating the actuator at the target actuator speed or the modified target actuator speed to achieve the target clamping force.

2. The method for controlling an actuator as claimed in claim 1, wherein the providing the target clamping force is performed by a vehicle controller, by an on-board computer or another vehicle computer.

3. The method for controlling an actuator as claimed in claim 1, further comprising detecting a currently applied clamping force of the actuator as the actual clamping force.

4. The method for controlling an actuator as claimed in claim 1, wherein the actual clamping force is additionally taken into account for calculating the torque.

5. The method for controlling an actuator as claimed in claim 1, wherein a maximum power of the actuator, which does not exceed the limit value, is achieved at the modified target actuator speed.

6. The method for controlling an actuator as claimed in claim 1, wherein the modified target actuator speed is once again limited to a modified corrected target actuator by a correction factor and the actuator is operated at the corrected target actuator speed.

7. The method for controlling an actuator as claimed in claim 6, wherein the correction factor is selected depending on other factors, including the temperature of the actuator, the availability of the on-board electrical system or critical rotation speeds or actuator speeds, wherein the correction factor is selected from a matrix stored in a memory.

8. The method for controlling an actuator as claimed in claim 6, wherein at least one of the modifying and the correcting the target actuator speed can be overridden or suspended when one of a superordinate vehicle controller, an on-board computer, and another vehicle computer specifies this.

9. The method for controlling an actuator as claimed claim 1, wherein selecting the correction value for determining the corrected target actuator speed is performed using a decision matrix stored in a memory.

10. The method for controlling an actuator as claimed in claim 1, wherein at least one of the reducing the target actuator speed, the modifying the target actuator speed and the correcting the target actuator speed is performed precisely once when a target value for the target clamping force is received.

11. The method for controlling an actuator as claimed in claim 6, wherein at least one of the reducing the target actuator speed, the modifying the target actuator speed and the correcting the target actuator speed is cyclically performed until the target clamping force is achieved.

12. The method for controlling an actuator as claimed in claim 1, wherein detecting the actual clamping force is performed by one of a force sensor and a model stored in a memory.

13. The method for controlling an actuator as claimed in claim 1, wherein a force controller unit is provided for carrying out the control method.

14. A force controller unit for use with a control device for a motor vehicle brake designed for carrying out the following steps:
providing a target value to be achieved for a clamping force of the actuator as a target clamping force;
calculating a target value for an actuator speed as a target actuator speed based on the target clamping force;
calculating a torque based on the target actuator speed;
calculating required braking power of the actuator based on the torque and the target actuator speed;
checking whether the braking power exceeds a specified limit value for a maximum power of the actuator;
reducing the target actuator speed to a modified target actuator speed if the specified limit value is exceeded; and
operating the actuator at the target actuator speed or the modified target actuator speed to achieve the target clamping force.

15. A motor vehicle comprising an electromechanical motor vehicle brake having a force controller unit designed for carrying out the following steps:
providing a target value to be achieved for a clamping force of the actuator as a target clamping force;
calculating a target value for an actuator speed as a target actuator speed based on the target clamping force;
calculating a torque based on the target actuator speed;
calculating required braking power of the actuator based on the torque and the target actuator speed;
checking whether the braking power exceeds a specified limit value for a maximum power of the actuator;
reducing the target actuator speed to a modified target actuator speed if the specified limit value is exceeded; and
operating the actuator at the target actuator speed or the modified target actuator speed to achieve the target clamping force.
